(19) United States
(12) Patent Application Publication
(10) Pub. No.: US 2025/0142422 A1
(43) Pub. Date: May 1, 2025

(54) SIGNAL MEASUREMENTS

(71) Applicant: Nokia Technologies Oy, Espoo (FI)

(72) Inventors: Umur KARABULUT, Munich (DE); Ahmad AWADA, Munich (DE); Panagiotis SPAPIS, Munich (DE); Subhyal Bin IQBAL, Munich (DE); Alperen GUNDOGAN, Munich (DE); Halit Murat GÜRSU, Munich (DE); Christian ROM, Aalborg (DK)

(21) Appl. No.: 18/836,699

(22) PCT Filed: Feb. 21, 2022
(86) PCT No.: PCT/EP2022/054273

§ 371 Date: Aug. 7, 2024

(51) Int. Cl. H04W 36/00

(52) U.S. Cl. CPC H04W 36/0058; H04W 36/0016; H04W 36/00837

(57) ABSTRACT

An apparatus, method and computer program is described comprising: obtaining signal measurements from a plurality of antenna panels of a user device at respective first sampling rates corresponding to each of the plurality of antenna panels, wherein a rate at which each of the plurality of antenna panels perform signal measurements is determined based on the respective first sampling rates; determining whether a first condition is satisfied or whether a second condition is satisfied, wherein at least one of the first condition or the second condition relates to a probability of an inbound handover; and increasing at least one of the respective first sampling rates to one or more respective second sampling rates in response to determining that the first condition is satisfied, or decreasing at least one of the first sampling rates to one or more respective third sampling rates in response to determining that the second condition is satisfied.

### FIELD

The present specification relates to obtaining signal measurements at user devices, such as mobile communication devices.

### BACKGROUND

It is known to obtain signal measurements at user devices in a mobile communications environment. There remains a need for improvement in how or when signal measurements are obtained.

### SUMMARY

In a first aspect, this specification provides an apparatus comprising: means for obtaining signal measurements from a plurality of antenna panels of a user device at respective first sampling rates corresponding to each antenna panel of the plurality of antenna panels, wherein a rate at which each antenna panel of the plurality of antenna panels performs signal measurements is determined based on the respective first sampling rates; means for determining at least one of whether a first condition is satisfied or whether a second condition is satisfied, wherein at least one of the first condition or the second condition relates to a probability of an inbound handover; and means for increasing at least one of the respective first sampling rates to one or more respective second sampling rates in response to determining that the first condition is satisfied, or decreasing at least one of the first sampling rates to one or more respective third sampling rates in response to determining that the second condition is satisfied.

Some examples include means for selecting at least one of the respective first sampling rates to be increased, based at least partially, on a determination of at least one antenna panel of the plurality of panels that is used for obtaining signal measurements relating to a serving cell and a target cell.

In some examples, the determination of whether the first condition is satisfied is performed based on a difference at which a signal measurement relating to a/the target cell is higher than a signal measurement relating to a/the serving cell, wherein the first condition is satisfied when the difference is higher than a first threshold difference (e.g. 1 to 6 decibels for a baseline handover scenario, or 1 to 21 decibels for a conditional handover scenario).

In some examples, the determination of whether the second condition is satisfied is performed based on a/the difference at which a signal measurement relating to a/the target cell is higher than a signal measurement relating to a/the serving cell, wherein the second condition is satisfied when the difference is lower than a second threshold difference.

In some examples, the determination of whether the first condition is satisfied is performed based on an elapsed time since a trigger event, wherein the trigger event occurs in response to a signal measurement corresponding to a target cell being higher, by at least a first offset value, than a signal measurement corresponding to a serving cell, wherein the first condition is satisfied if the elapsed time is higher than a first threshold time.

In some examples, the determination of whether the second condition is satisfied is performed based on the elapsed time since the trigger event, wherein the second condition is satisfied if the elapsed time is lower than a second threshold time.

In some examples, the first condition is satisfied in response to at least one of: determining that a conditional handover condition is satisfied, or a handover preparation is complete.

In some examples, the second condition is satisfied in response to determining that determining that a conditional handover condition is not satisfied, or a handover preparation is not complete.

In some examples, the first condition is satisfied in response to determining that a difference at which a signal measurement relating to a target cell of the user device is higher than a signal measurement relating to a serving cell of the user device, is higher than a third threshold difference. In these examples, the apparatus may further comprise means for: increasing at least one of the second sampling rates to one or more respective fourth sampling rates in the event that a third condition is satisfied, wherein the third condition is satisfied in response to determining that an elapsed time since a trigger event is higher than a third threshold time, wherein the trigger event occurs in response to a signal measurement corresponding to a target cell being higher, by at least a first offset value, than a signal measurement corresponding to a serving cell; and increasing at least one of the fourth sampling rates to one or more respective fifth sampling rates in the event that a fourth condition is satisfied, wherein the fourth condition is satisfied in response to at least one of: determining that a conditional handover condition is satisfied or a handover preparation is complete. Some examples further include means for increasing at least one of the fifth sampling rates to one or more sixth sampling rates in the event that a fifth condition is satisfied, wherein the fifth condition is satisfied when a handover execution condition is satisfied. In some of these examples (e.g. for a time to trigger counter being equal to 160 milliseconds), the first sampling rate corresponds to a first sampling period of 160 milliseconds; the second sampling rate corresponds to a second sampling period of 100 milliseconds; the fourth sampling rate corresponds to a fourth sampling period of 80 milliseconds; the fifth sampling rate corresponds to a fifth sampling period of 60 milliseconds; and the sixth sampling rate corresponds to a sixth sampling period of 20 milliseconds.

In some examples, the second condition is satisfied in response to determining that a conditional handover condition is not satisfied, or a handover preparation is not complete. In these examples, the apparatus further comprises means for: decreasing at least one of the third sampling rates to one or more respective seventh sampling rates in the event that a sixth condition is satisfied, wherein the sixth condition is satisfied in response to determining that an elapsed time since a trigger event is lower than a fourth threshold time, wherein the trigger event occurs in response to a signal measurement corresponding to a target cell being higher, by at least a first offset value, than a signal measurement corresponding to a serving cell; and decreasing at least one of the seventh sampling rates to one or more respective eighth sampling rates in the event that a seventh condition is satisfied, wherein the seventh condition is satisfied in response to determining that a difference, at which a signal measurement relating to a/the target cell is higher than a signal measurement relating to a/the serving cell, is lower than a fourth difference threshold. In some of these examples (e.g. for a time to trigger counter being equal to 160 milliseconds), the first sampling rate corresponds to a first sampling period of 40 milliseconds; the third sampling rate corresponds to a second sampling period of 80 milliseconds; the seventh sampling rate corresponds to a fourth sampling period of 100 milliseconds; and the eighth sampling rate corresponds to a fifth sampling period of 160 milliseconds.

The means may comprise: at least one processor; and at least one memory including computer program code, the at least one memory and the computer program code configured, with the at least one processor, to cause the performance of the apparatus.

In a second aspect, this specification describes a method comprising: obtaining signal measurements from a plurality of antenna panels of a user device at respective first sampling rates corresponding to each antenna panel of the plurality of antenna panels, wherein a rate at which each antenna panel of the plurality of antenna panels performs signal measurements is determined based on the respective first sampling rates; determining at least one of whether a first condition is satisfied or whether a second condition is satisfied, wherein at least one of the first condition or the second condition relates to a probability of an inbound handover; and increasing at least one of the respective first sampling rates to one or more respective second sampling rates in response to determining that the first condition is satisfied, or decreasing at least one of the first sampling rates to one or more respective third sampling rates in response to determining that the second condition is satisfied.

Some examples may further comprise selecting at least one of the respective first sampling rates to be increased, based at least partially, on a determination of at least one antenna panel of the plurality of panels that is used for obtaining signal measurements relating to a serving cell and a target cell.

In some examples, the determination of whether the first condition is satisfied is performed based on a difference at which a signal measurement relating to a/the target cell is higher than a signal measurement relating to a/the serving cell, wherein the first condition is satisfied when the difference is higher than a first threshold difference.

In some examples, the determination of whether the second condition is satisfied is performed based on a/the difference at which a signal measurement relating to a/the target cell is higher than a signal measurement relating to a/the serving cell, wherein the second condition is satisfied when the difference is lower than a second threshold difference.

In some examples, the determination of whether the first condition is satisfied is performed based on an elapsed time since a trigger event, wherein the trigger event occurs when signal measurements corresponding to a target cell is higher, by at least a first offset value, than signal measurements corresponding to a serving cell, wherein the first condition is satisfied if the elapsed time is higher than a first threshold time.

In some examples, the determination of whether the second condition is satisfied is performed based on the elapsed time since the trigger event, wherein the second condition is satisfied if the elapsed time is lower than a second threshold time.

In some examples, the first condition is satisfied in response to at least one of: determining that a conditional handover condition is satisfied, or a handover preparation is complete.

In some examples, the second condition is satisfied in response to determining that determining that a conditional handover condition is not satisfied, or a handover preparation is not complete.

In some examples, the first condition is satisfied in response to determining that a difference at which a signal measurement relating to a target cell of the user device is higher than a signal measurement relating to a serving cell of the user device, is higher than a third threshold difference. In these examples, the method may further comprise: increasing at least one of the second sampling rates to one or more respective fourth sampling rates in the event that a third condition is satisfied, wherein the third condition is satisfied in response to determining that an elapsed time since a trigger event is higher than a third threshold time, wherein the trigger event occurs in response to a signal measurement corresponding to a target cell being higher, by at least a first offset value, than a signal measurement corresponding to a serving cell; and increasing at least one of the fourth sampling rates to one or more respective fifth sampling rates in the event that a fourth condition is satisfied, wherein the fourth condition is satisfied in response to at least one of: determining that a conditional handover condition is satisfied or a handover preparation is complete. Some examples further include means for increasing at least one of the fifth sampling rates to one or more sixth sampling rates in the event that a fifth condition is satisfied, wherein the fifth condition is satisfied when a handover execution condition is satisfied. In some of these examples (e.g. for a time to trigger counter being equal to 160 milliseconds), the first sampling rate corresponds to a first sampling period of 160 milliseconds; the second sampling rate corresponds to a second sampling period of 100 milliseconds; the fourth sampling rate corresponds to a fourth sampling period of 80 milliseconds; the fifth sampling rate corresponds to a fifth sampling period of 60 milliseconds; and the sixth sampling rate corresponds to a sixth sampling period of 20 milliseconds.

In some examples, the second condition is satisfied in response to determining that a conditional handover condition is not satisfied, or a handover preparation is not complete. In these examples, the method may further comprise: decreasing at least one of the third sampling rates to one or more respective seventh sampling rates in the event that a sixth condition is satisfied, wherein the sixth condition is satisfied in response to determining that an elapsed time since a trigger event is lower than a fourth threshold time, wherein the trigger event occurs in response to a signal measurement corresponding to a target cell being higher, by at least a first offset value, than a signal measurement corresponding to a serving cell; and decreasing at least one of the seventh sampling rates to one or more respective eighth sampling rates in the event that a seventh condition is satisfied, wherein the seventh condition is satisfied in response to determining that a difference, at which a signal measurement relating to a/the target cell is higher than a signal measurement relating to a/the serving cell, is lower than a fourth difference threshold. In some of these examples (e.g. for a time to trigger counter being equal to 160 milliseconds), the first sampling rate corresponds to a first sampling period of 40 milliseconds; the third sampling rate corresponds to a second sampling period of 80 milliseconds; the seventh sampling rate corresponds to a fourth sampling period of 100 milliseconds; and the eighth sampling rate corresponds to a fifth sampling period of 160 milliseconds.

In a third aspect, this specification describes an apparatus configured to perform any method as described with reference to the second aspect.

In a fourth aspect, this specification describes computer-readable instructions which, when executed by computing apparatus, cause the computing apparatus to perform any method as described with reference to the second aspect.

In a fifth aspect, this specification describes a computer program comprising instructions for causing an apparatus to perform at least the following: obtaining signal measurements from a plurality of antenna panels of a user device at respective first sampling rates corresponding to each antenna panel of the plurality of antenna panels, wherein a rate at which each antenna panel of the plurality of antenna panels performs signal measurements is determined based on the respective first sampling rates; determining at least one of whether a first condition is satisfied or whether a second condition is satisfied, wherein at least one of the first condition or the second condition relates to probability of an inbound handover; and increasing at least one of the first sampling rates to one or more respective second sampling rates in response to determining that the first condition is satisfied, or decreasing at least one of the first sampling rates to one or more respective third sampling rates in response to determining that the second condition is satisfied.

In a sixth aspect, this specification describes a computer-readable medium (such as a non-transitory computer-readable medium) comprising program instructions stored thereon for performing at least the following: obtaining signal measurements from a plurality of antenna panels of a user device at respective first sampling rates corresponding to each antenna panel of the plurality of antenna panels, wherein a rate at which each antenna panel of the plurality of antenna panels performs signal measurements is determined based on the respective first sampling rates; determining at least one of whether a first condition is satisfied or whether a second condition is satisfied, wherein at least one of the first condition or the second condition relates to probability of an inbound handover; and increasing at least one of the first sampling rates to one or more respective second sampling rates in response to determining that the first condition is satisfied, or decreasing at least one of the first sampling rates to one or more respective third sampling rates in response to determining that the second condition is satisfied.

In a seventh aspect, this specification describes an apparatus comprising: at least one processor; and at least one memory including computer program code which, when executed by the at least one processor, causes the apparatus to: obtain signal measurements from a plurality of antenna panels of a user device at respective first sampling rates corresponding to each antenna panel of the plurality of antenna panels, wherein a rate at which each antenna panel of the plurality of antenna panels performs signal measurements is determined based on the respective first sampling rates; determine at least one of whether a first condition is satisfied or whether a second condition is satisfied, wherein at least one of the first condition or the second condition relates to probability of an inbound handover; and increase at least one of the first sampling rates to one or more respective second sampling rates in response to determining that the first condition is satisfied, or decreasing at least one of the first sampling rates to one or more respective third sampling rates in response to determining that the second condition is satisfied.

In an eighth aspect, this specification describes an apparatus comprising: a first module configured to obtain signal measurements from a plurality of antenna panels of a user device at respective first sampling rates corresponding to each antenna panel of the plurality of antenna panels, wherein a rate at which each antenna panel of the plurality of antenna panels performs signal measurements is determined based on the respective first sampling rates; a second module configured to determine at least one of whether a first condition is satisfied or whether a second condition is satisfied, wherein at least one of the first condition or the second condition relates to probability of an inbound handover; and a third module configured to increase at least one of the first sampling rates to one or more respective second sampling rates in response to determining that the first condition is satisfied, or decreasing at least one of the first sampling rates to one or more respective third sampling rates in response to determining that the second condition is satisfied.

### BRIEF DESCRIPTION OF THE DRAWINGS

Example embodiments will now be described, by way of example only, with reference to the following schematic drawings, in which:

FIGS. 1 and 2 are block diagrams of systems in accordance with example embodiments;

FIG. 3 illustrates plots showing signal measurements obtained at a user device;

FIGS. 4 to 9 are flowcharts of algorithms in accordance with example embodiments;

FIG. 10 is a block diagram of components of a system in accordance with an example embodiment; and

FIG. 11 shows an example of tangible media for storing computer-readable code which when run by a computer may perform methods according to example embodiments described above.

### DETAILED DESCRIPTION

The scope of protection sought for various embodiments of the invention is set out by the independent claims. The embodiments and features, if any, described in the specification that do not fall under the scope of the independent claims are to be interpreted as examples useful for understanding various embodiments of the invention.

In the description and drawings, like reference numerals refer to like elements throughout.

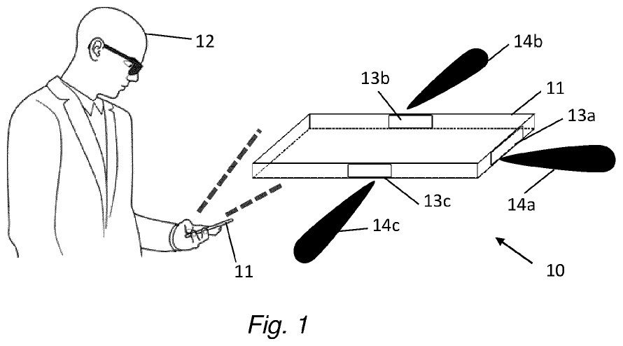

FIG. 1 is a block diagram of a system, indicated generally by the reference numeral 10, in accordance with an example embodiment. System 10 shows a user device 11 being used by a user 12. The user device 11 is also shown in an enlarged view, having a plurality of antenna panels 13. The user device 11 may be a multi-panel user equipment (MPUE) having, for example, three antenna panels 13a, 13b, and 13c. Each of the panels 13a, 13b, and 13c may have a directional radiation pattern as shown by the beam directions 14a, 14b, and 14c (2 dimensional illustrations) respectively, thus covering multiple spatial directions.

In 3GPP 5G NR (3rd Generation Partnership Project 5G, New Radio) standards, the use of mmWave has influenced the requirement to compensate for the additional path loss at higher frequencies, further leading to the use of antenna arrays at base stations and User Equipment (UE). Patch arrays for mmWave at UE level may be directional with, for example, up to 30 dB front-to-back ratio and may enable, through their size, the provision of multiple array panels covering multiple spatial directions. In one example, user devices (e.g. MPUEs), such as user device 11, may activate all antenna panels 13a, 13b, 13c simultaneously for simultaneous measurements of serving cell and target or neighbour cell (e.g. Assumption 3 in R1-1907860; depending on UE hardware architecture, MPUE hardware categories have been discussed on R1-1907860). In another example, each panels 13a, 13b, and 13c can be activated independently with different activation frequencies. The activation periodicity of each panel may be used for determining the sampling rate of each panel, i.e., how often a panel does sampling of cell measurements over time.

Signal measurements obtained by user devices (UE measurements) may be an important part of the mobility in mobile networks. User devices may measure the quality of serving cell and target cells (or neighbour cells) and report the obtained signal measurements to the network (e.g. base station), where those measurements are used by the network to decide handover of the user device from one cell to another. Inaccurate cell quality measurements may lead to faulty handover decisions in the network and may cause user devices to experience service interruption (e.g., Radio Link Failure (RLF), Handover Failure (HOF) or Ping-Pong (PP)). Therefore, it may be advantageous for user devices to achieve accurate cell quality measurements and good mobility performance. Sampling rate of each panel and panel activation periodicity may be based on UE implementation. In the case of multi-panel UEs, sampling rate of each panel may have an impact on mobility performance.

In one example, a user device, such as the user device 11, may measure the reference signal power of a serving cell and neighbour cells periodically to assess the quality of each cell to be used in handover decisions. Using a low sampling rate may lead to obtaining low number of samples (or statistics) which may be insufficient or inaccurate for assessing mobility or handover conditions. On the other hand, using a high sampling rate may increase the power consumption of the user device as more measurements are obtained, leading to drainage of the user device battery over time.

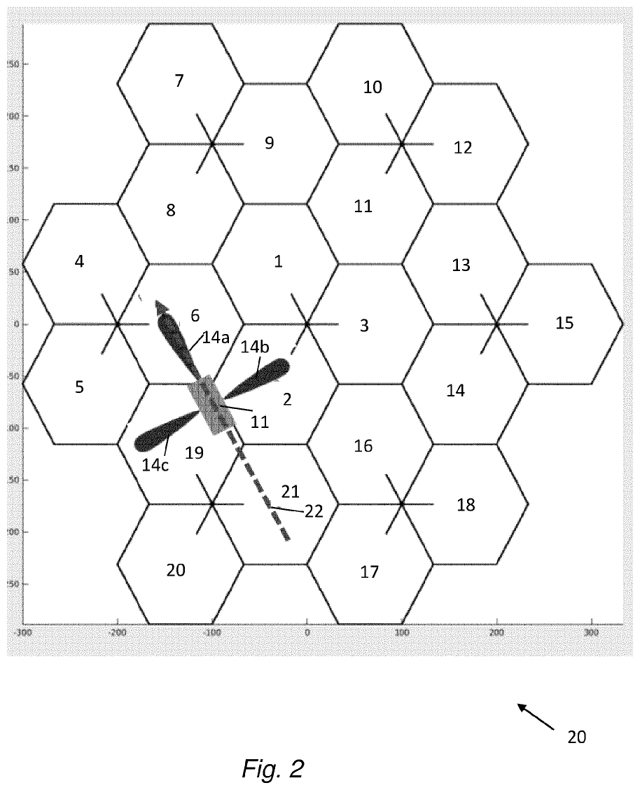

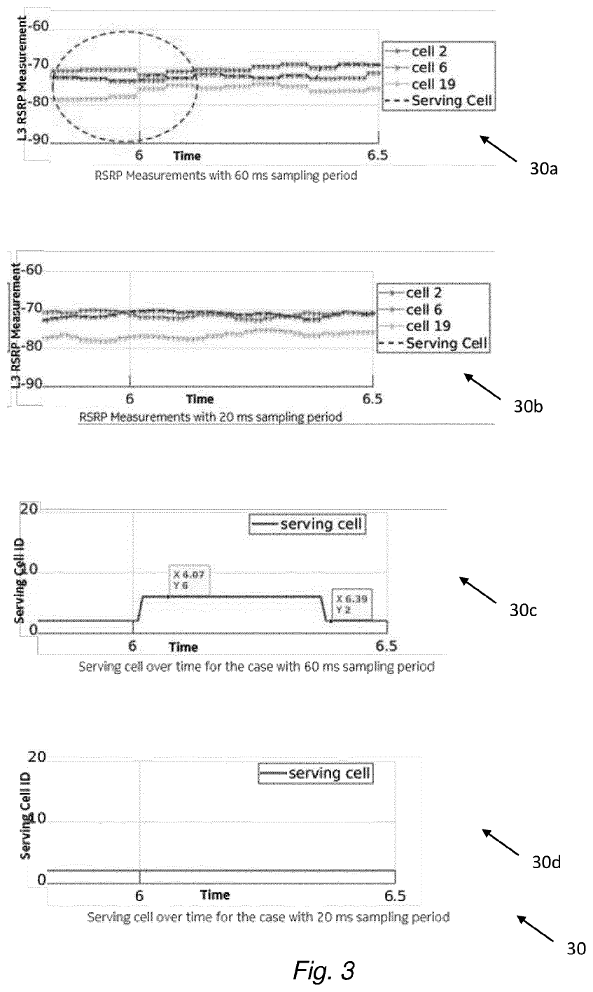

FIG. 2 is a block diagram of a system, indicated generally by the reference numeral 20, in accordance with an example embodiment. The system 20 shows the user device 11 traversing a network with a plurality of cells (e.g. cells 1 to 21 shown as hexagons). The user device 11 comprises the three antenna panels 13a, 13b and 13c described above having directional radiation patterns shown by beam directions 14a, 14b, and 14c. The user device 11 may be traversing in the direction shown with the dashed arrow 22. An example mobility scenario and signal measurements of the user device are further described below with reference to FIG. 3.

FIG. 3 illustrates plots, indicated generally by the reference numeral 30, showing signal measurements obtained at a user device (e.g. user device 11) with respect to time. As described above with reference to FIG. 2, the user device 11 may have a mobility direction shown by the arrow 22. In FIG. 2, the user device 11 is shown to be at a border of cells 2, 6, and 19, and the user device 11 is shown to be moving in the direction of cell 6. The user device 11 may initially be served by cell 2.

Plot 30a shows reference signal received power (RSRP) measurements (for at least cell 2, cell 6, and cell 19) with respect to time when sampling period is 60 milliseconds (which may be considered to be a relatively low sampling rate). Plot 30b shows reference signal received power (RSRP) measurements with respect to time when sampling period is 20 milliseconds (which may be considered to be a relatively high sampling rate). The relatively low sampling rate in plot 30a may cause the user device to use non-updated measurements for L3 filtering and for evaluating handover conditions. In plot 30b, with relatively high sampling rate, it can be seen that just before time 6 (s) that the value of L3 RSRP measurement of cell 6 drops down and the L3 RSRP measurement of serving cell 2 increases after some time. This drop in L3 RSRP measurement is not be observed in plot 30a due to the relatively low sampling rate.

Plot 30c shows serving cell ID with respect to time with the sampling period of 60milliseconds (corresponding to RSRP measurements shown in plot 30a) and plot 30d shows serving cell ID with respect to time with the sampling period of 20 milliseconds (corresponding to RSRP measurements shown in plot 30b). In plot 30c, it can be seen that a handover is performed from cell 2 to cell 6 as time 6 (s) and another handover is performed from cell 6 to cell 2 just before 6.5 (s), although UE could have stayed in the serving cell 2 (as illustrated in FIG. 3d) to avoid unnecessary handover, e.g., ping pong. In plot 30d, it can be seen that no unnecessary handover is performed, and the user device stays in cell 6, which is a result of the more accurate results obtained from the relatively high sampling rate (20 ms sampling period).

The example embodiments described below provide techniques that seek to determine optimal sampling rates based on different situations and assumptions.

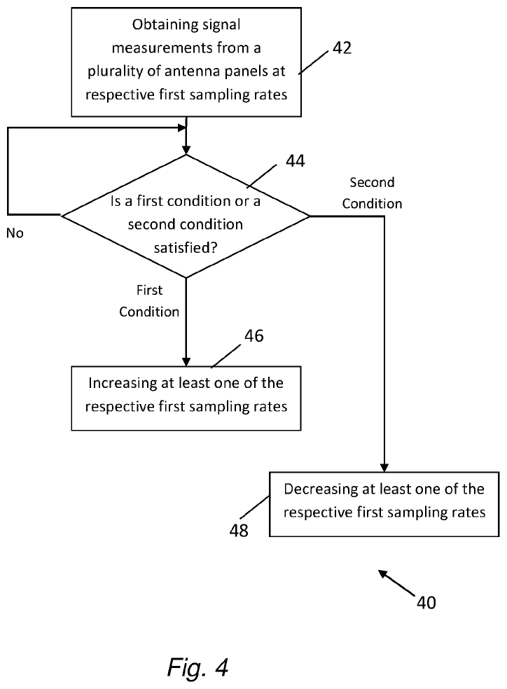

FIG. 4 is a flowchart of an algorithm, indicated generally by the reference numeral 40, in accordance with an example embodiment.

The algorithm 40 starts with operation 42 where signal measurements are obtained from a plurality of antenna panels (e.g. the antenna panels 13a, 13b, 13c) of a user device (e.g. the user device 11) at respective first sampling rates corresponding to each antenna panel of the plurality of antenna panels. A rate (e.g. sampling rate) and/or an order at which each of the plurality of antennas perform signal measurements may be determined based on the respective first sampling rates. In one example, the signal measurements may comprise one or more of reference signal received power (RSRP) measurements, or reference signal received quality (RSRQ) measurements.

For example, one or more of the plurality of antenna panels 13a, 13b, and 13c may have different sampling rates (e.g. rate at which signal measurements are obtained) or may have the same sampling rates. As such, one or more of the plurality of antenna panels may obtain signal measurements simultaneously (e.g. periodically, at substantially the same time), or independently of each other (e.g. periodically, at different times, at different sampling rates). The respective first sampling rates may be initial sampling rates (e.g. default sampling rates prior to a handover situation). In one example, sampling rates of each of the panels may be dependent upon prioritization (e.g.

predefined prioritization rules), such that some panels may be activated more often than other panels. For example, panel(s) having a beam direction in the direction of mobility (e.g. the panel 13a having beam direction 14a in the mobility direction shown by the arrow 22 with reference to FIGS. 1 and 2) of the user device may have a higher sampling rate compared to panel(s) not having a beam direction in the direction of mobility. Alternatively, or in addition, other prioritization rules may be implemented.

Next, the algorithm 40 moves to operation 44, where a determination is made regarding at least one of the following: whether a first condition is satisfied or whether a second condition is satisfied. At least one of the first condition or the second condition relates to a probability of an inbound handover or a prediction of a handover. For example, based on the first or second condition being satisfied, a prediction can be made of how soon a handover should occur or is likely to occur. In one example, the operation 44 may be repeated (e.g. periodically) if neither the first condition nor the second condition is satisfied.

If the first condition is satisfied, the algorithm 40 moves to operation 46, where at least one of the respective first sampling rates is increased to one or more respective second sampling rates. For example, the first (initial) sampling rate of at least one of the plurality of panels (e.g. the panels 13a, 13b, 13c) may be increased in response to the first condition being satisfied. The first condition being satisfied may be an indication of the user device being close to a cell border such that a handover may occur due to the serving cell of the user device being changed, and increasing the sampling rate may assist in obtaining signal measurements with higher accuracy.

Alternatively, if the second condition is satisfied, algorithm 40 moves to operation 48, where at least one of the respective first sampling rates is decreased to one or more respective third sampling rates. The second condition being satisfied may be an indication of the user device not being close to a cell border such that a handover may not be likely to occur at least for some time, and decreasing the sampling rate may assist in reducing power consumption at the user device.

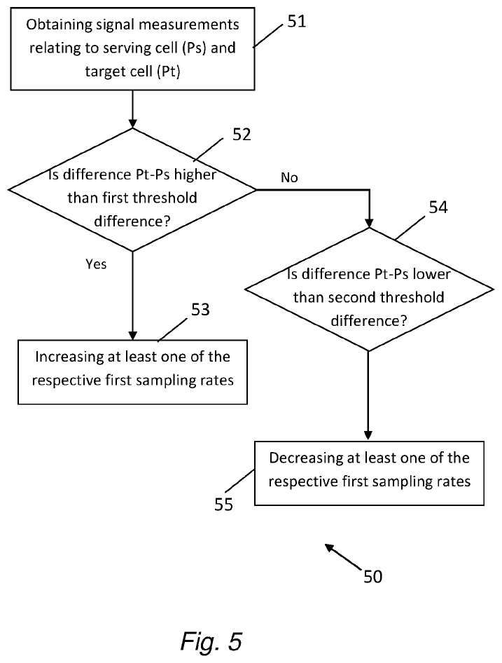

FIG. 5 is a flowchart of an algorithm, indicated generally by the reference numeral 50, in accordance with an example embodiment. The algorithm 50 may be an example of how the algorithm 40, described with reference to FIG. 4, may be implemented. The algorithm 50 starts with operation 51, where signal measurements (Ps) relating to at least one serving cell and signal measurements (Pt) relating to at least one target cell are obtained (e.g. monitored). For example, the signal measurements may be obtained or monitored by one or more of the plurality of panels based on the at least one first sampling rates. The operation 51 may be an example implementation of operation 42 as described above with reference to FIG. 4.

Next, at operation 52, a determination is made whether the difference (Pt-Ps), between the signal measurements of the target cell (Pt) and signal measurements of the serving cell (Ps) is higher than a first threshold difference. The difference (Pt-Ps) being higher than the first threshold difference may provide an indication that the user device is approaching a cell border such that a handover is likely to take place as the target cell signal measurements are much higher than the serving cell signal measurements, and increasing the sampling rate may assist in obtaining signal measurements with higher accuracy. The determination of whether the first condition is satisfied (e.g. operation 44) may be performed based on the difference at which a signal measurement relating to a target cell (Pt) of the user device is higher than a signal measurement relating to a serving cell (Ps) of the user device. For example, the first condition may be satisfied when the difference is higher than the first threshold difference.

In response to determining that the difference is higher than the first threshold difference, the first condition the algorithm 50 moves to operation 53, where at least one of the respective first sampling rates is increased to one or more second sampling rates (e.g. thereby implementing operation 46). In one example, when a handover scenario comprises a baseline handover, the first threshold difference is within the range of 1 to 6 decibels. In a further example, the first threshold difference is equal to 3decibels (e.g. for duration of time to trigger (TTT) being 160 ms, where time to trigger is a time period initiated after a trigger event (A3 trigger event where Pt becomes higher than Ps), at the end of which time period a handover is scheduled to be executed). In another example, if the handover scenario comprises a conditional handover (e.g. and a handover preparation condition is considered), the first threshold difference may be within the range of 1 to 21 decibels.

If the difference is not higher than the first threshold difference, operation 54 may be performed, where a determination is made whether the difference (Pt-Ps) is lower than a second threshold difference. The determination of whether the second condition is satisfied (e.g. operation 44) may be performed based on the difference at which signal measurement(s) relating to a target cell (Pt) of the user device is/are higher than signal measurement(s) relating to a serving cell (Ps) of the user device. For example, the second condition may be satisfied when the difference is lower than the second threshold difference.

In response to determining that the difference is lower than the second threshold difference, the algorithm 50 moves to operation 55, where at least one of the respective first sampling rates is decreased to one or more third sampling rates (e.g. thereby implementing operation 48). For example, the difference (Pt-Ps) being lower than the second threshold difference may provide an indication that the user device is not near or approaching a cell border and a handover is not likely to occur for at least some time, and decreasing the sampling rate may assist in reducing power consumption at the user device.

In one example, initially when the algorithm 50 starts with obtaining or monitoring signal measurements, the serving cell RSRP may have higher values compared to the RSRP measurements of any target cells (e.g. Ps>Pt or Pt-Ps<second threshold difference; operation 55) which may indicate that the user device is far from satisfying the handover condition (thus implying that the user device is located in the cell centre or away from the cell border). Hence, the user device may reduce the sampling rate, thus increasing the RSRP measurements sampling period (e.g. by setting it to a high value, e.g., 80 ms), thus reducing the power consumption. When the user device gets closer to the cell border, the RSRP measurements of the target cell may increase over time and the difference between serving cell and target cell measurement values becomes lower. This is detected at operation 52 (e.g. Pt-Ps>first threshold difference).

At this stage, the handover condition may not be satisfied, or handover preparation may not be initiated, but the algorithm nevertheless may proceed to operation 53. The user device may increase the sampling rate, thus reducing the sampling period (e.g. from 80 ms to 20 ms), which may assist in monitoring the handover condition with accurate RSRP measurements since it is more likely than before that the handover condition will be satisfied.

In an example embodiment, the increasing of the sampling rates at operation 46 or 53 may apply to relevant antenna panels, while the sampling rates of non-relevant antenna panels may be kept the same as an initial first sampling rate. For example, the relevant antenna panels may include antenna panels of the user device that are used for monitoring or obtaining (and consequently comparing) the signal measurements of the serving cell and the target cell. As such, the operations 46 and/or 53 may further comprise selecting at least one of the respective first sampling rates to be increased, based at least partially, on a determination of at least one antenna panel (e.g. relevant antenna panels) of the plurality of antenna panels that is used for obtaining signal measurement(s) relating to a serving cell and a target cell. For example, with reference to FIG. 2, where cell 2 is a serving cell and cell 6 is a target cell, the panel 13b (beam direction 14b) may be used for obtaining signal measurements for the serving cell (cell 2) and the panel 13a (beam direction 14a) may be used for obtaining signal measurements for the target cell (cell 6). Non-relevant panels may include the remaining panel(s) (panel 13c with beam direction 14c), for example, having signal measurements for the target cell that are less than a certain relevancy threshold, implying that these non-relevant panels may not be used, or may not be crucial for mobility events, such as a handover. Hence, by only increasing sampling rates of relevant panels and not increasing sampling rates of non-relevant panels, the user device may conserve power (e.g. increasing the power consumption in a limited manner) while still obtaining accurate measurements required for a mobility event.

In another example embodiment, the increasing of the sampling rates at operation 46 or 53 may apply to all panels (13a, 13b, 13c) of the user device. This may assist in avoiding any rotation-related inaccuracy adaptation over time.

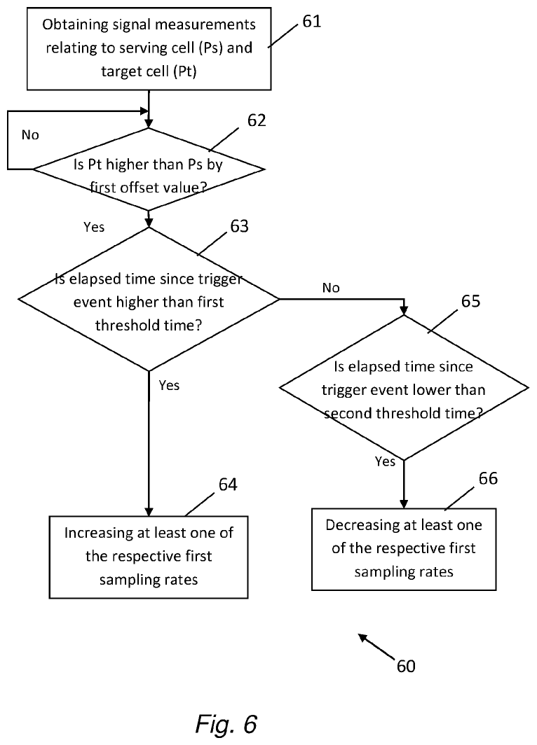

FIG. 6 is a flowchart of an algorithm indicated generally by the reference numeral 60, in accordance with an example embodiment. At operation 61, signal measurements (e.g. RSRP measurements) relating to the serving cell (Ps) and signal measurements relating to the target cell (Pt) are obtained (e.g. using at least one first sampling rates at one or more of the plurality of panels). Next, at operation 62, a determination is made of whether a trigger event (e.g. an A3 trigger event) has occurred, by determining whether signal measurements corresponding to the target cell (Pt) has become higher, at least by a first offset value (e.g. any value more than or equal to zero decibels), than the signal measurements corresponding to the serving cell (Ps). The user device may continue monitoring signal measurements if the first trigger event has not occurred.

In response to determining that the first trigger event has occurred, the algorithm 60 moves to operation 63 and determines whether an elapsed time since the trigger event is higher than a first threshold time. If the elapsed time is higher than the first threshold time, operation 64 is performed where at least one of the respective first sampling rates is increased to one or more second sampling rates. For example, the elapsed time since an A3 trigger event being higher than the first threshold time may be an indication that a handover is likely to occur soon, and therefore sampling rate(s) may be increased for higher accuracy in obtaining signal measurements. As described above in relation to operations 46 and 53, the increasing of the sampling rates at operation 64 may apply to relevant panels only, or may apply to all panels of the user device.

If elapsed time is not higher than the first threshold time, operation 65 may be performed for determining whether the elapsed time since the trigger event is lower than a second threshold time. If such a determination is made, operation 66 is performed and at least one of the respective first sampling rates is decreased to one or more third sampling rates. For example, the elapsed time since an A3 trigger event being lower than the second threshold time may be an indication that a handover is not likely to occur soon, and therefore sampling rate(s) may be decreased for reducing power consumption.

In the above example, the likelihood of a handover being executed may be determined based on elapsed time since a time to trigger (TTT) counter started (e.g. the trigger event occurring). In some examples, the TTT counter starting may be a final criterion to be satisfied before UE initiates the handover procedure. The purpose of the TTT counter may be to ensure that the handover condition(s) are satisfied at least for a specific time period, and are not only satisfied momentarily, such that handover execution is completed once the TTT counter ends. The user device having slow sampling rate after the TTT counter has started may negatively affect the functionality aimed by the TTT counter, where the user device should ideally take enough measurements required for executing the handover at the end of the TTT counter. For example, if the TTT is 160 ms, and the sampling period is 80 ms, the user device may only obtain two measurements within the TTT period, which may not be sufficient for executing a handover. Thus, once the elapsed time after starting the TTT counter is higher than a first threshold time (operation 63), the user device increases at least one of the respective first sampling rates at operation 64. For example, for a TTT of 160 ms, the sampling rate may be increased such that the sampling period is reduced from 80 ms to 20 ms, thus allowing the user device to collect more statistics or obtain updated measurements, such that the network can initiate the handover procedure when necessary or appropriate.

In an example embodiment, the sampling rate(s) may be increased based on both the example embodiments described with reference to FIGS. 5 and 6 (i.e. the algorithms 50 and 60 may be combined). In one example embodiment, the above algorithms 50 and 60 are implemented in a hierarchical manner, where the algorithm 50 is first implemented (sampling rate(s) being increased based on difference Pt-Ps being higher than first threshold difference; for example sampling period reduced from 80 ms to 60 ms) and then algorithm 60 is implemented (sampling rate(s) further being increased based on elapsed time since trigger event being higher than the first threshold time; for example sampling period reduced from 60 ms to 20 ms).

In another example embodiment, the algorithm 60 is performed independently of the algorithm 50, or without performing the algorithm 50. For example, the user device may not increase sampling rate based on the difference Pt-Ps being higher than the first threshold difference, thus saving power, but may later increase sampling rate when the elapsed time since the trigger event is higher than the first threshold time (operation 63 and 64). For example, this may be beneficial when the user device may have a low battery level, and may postpone the increasing of the sampling rate until the condition of operation 63 is satisfied.

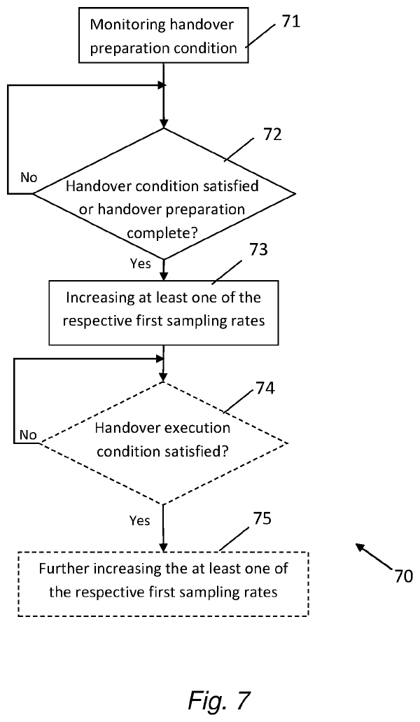

FIG. 7 is a flowchart of an algorithm, indicated generally by the reference numeral 70, in accordance to an example embodiment. The algorithm 70 starts at operation 71, where the user device monitors a handover preparation condition. For example, the user device may be configured with conditional handover (CHO) as a handover mechanism. The operation 71 may comprise the user device monitoring the handover preparation condition of the target cells (e.g. in Rel.16 CHO [TS38.300]).

Next, at operation 72, the user device determines at least one of whether a handover condition is satisfied or whether a handover preparation is complete. For example, once the handover condition is satisfied, the serving cell may prepare the target cell and send a handover execution condition to the user device. For example, the handover condition may comprise an entry condition of conditional handover preparation or execution (e.g. determined based on comparison of RSRP of target cell and serving cell). If the handover condition is not satisfied, or a handover preparation is not complete, operation 72 may be repeated, for example, for periodically monitoring the handover condition or handover preparation.

In response to determining that the handover condition is satisfied or a handover preparation is complete, operation 73 is performed by increasing at least one of the respective first sampling rates to one or more respective second sampling rates (similar to operations 46, 53 and 64 described with reference to FIGS. 4, 5 and 6).

Next, operation 74 may be performed for determining whether a handover execution condition (e.g. entry condition of handover execution condition) has been satisfied (e.g. handover condition is satisfied but TTT is still running), and in response to determining that the handover execution condition is satisfied, operation 75 is performed by further increasing the at least one of the first sampling rates (thus further reducing the sampling period). If the handover execution condition is not satisfied, operation 74 may be repeated, for example, for periodically monitoring the handover execution condition. In one example, the operations 74 and 75 may be optional.

In an example embodiment, once the user device receives the handover execution condition (operation 74), the user device may start to monitor this the handover execution condition (e.g. whether the handover execution condition is satisfied) and the user device may execute the handover to target cell autonomously without any further signalling with the serving cell. A handover preparation and consequently the handover execution condition should be satisfied for the handover procedure to be completed. Therefore, signal measurements with higher accuracy may be needed after handover preparation is completed since it is more likely that the handover will be executed. The user device therefore increases the sampling rate(s) (thus decreasing the sampling period) when the handover preparation is satisfied such that the handover execution may be performed with more accurate measurements. For example, the initial first sampling rate used before operation 72 may correspond to a sampling period of approximately 80 ms. Once the handover preparation condition is satisfied at operation 72, the first sampling rate may be increased to correspond to a sampling period of 20 ms. Once the target cell is prepared for the handover, the network may provide to the user device the Radio Resource Control (RRC) reconfiguration (CHO Command) which may then be used by the user device for performing the handover (e.g. once the handover condition is satisfied). The user device may reduce the sampling rate from 80 ms to 20 ms (operation 73) once it receives the RRC reconfiguration (CHO Command), thus improving the accuracy of the measurements that are used for handover execution condition, since it is expected that a handover is likely to be performed. Alternatively, if the user device receives a CHO cancellation from the network, the sampling rate may be decreased by increasing the sampling period.

In an example embodiment, the sampling rate(s) are increased based on one or more of the example embodiments described with reference to FIGS. 5, 6, and 7. For example, the algorithms 50 and 60 may be combined, algorithms 60 and 70 may be combined, or algorithms 50 and 70 may be combined. In any combination, the order of performing the algorithms (whichever are included in the combination) may be as follows: algorithm 50, algorithm 60, algorithm 70. In one example embodiment, the above algorithms 50, 60, and 70 are implemented in a hierarchical manner, where the algorithm 50 is first implemented (sampling rate(s) being increased based on difference Pt-Ps being higher than first threshold difference; for example sampling period reduced from 160 ms to 80 ms); then algorithm 60 is implemented (sampling rate(s) further being increased based on elapsed time since trigger event being higher than the first threshold time; for example sampling period reduced from 80 ms to 60 ms); and then algorithm 70 is implemented (sampling rate(s) further being increased based on handover preparation condition being satisfied (e.g. sampling period reduced from 60 ms to 40 ms) or handover execution condition being satisfied (e.g. sampling period reduced from 40 ms to 20 ms)). Alternatively, the algorithm 70 is implemented without implementing any one or more of the algorithms 50 or 60, thus causing the user device to save power by increasing the sampling rate when the handover time is closer.

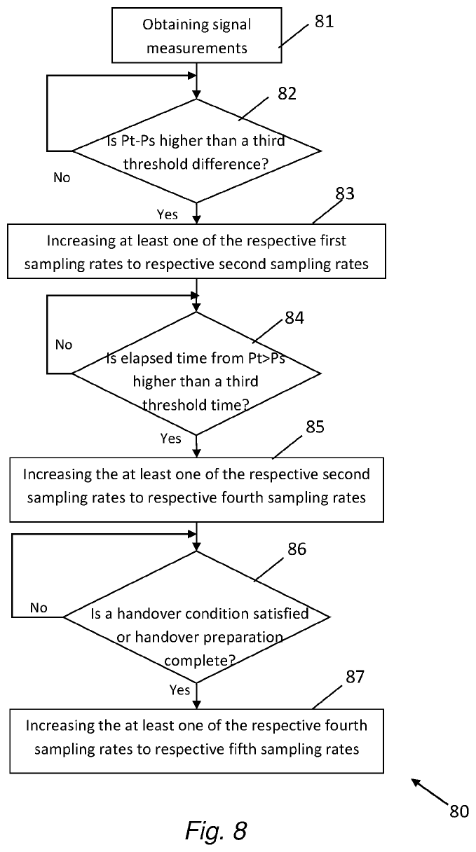

FIG. 8 is a flowchart of an algorithm, indicated generally by the reference numeral 80, in accordance with an example embodiment. The algorithm 80 may be a combination of the operations of algorithms 50, 60, and 70, implemented in a hierarchical order. The algorithm 80 starts with operation 81 by obtaining (or monitoring) signal measurements, for example, signal measurements (Ps) relating to at least one serving cell and signal measurements (Pt) relating to at least one target cell are obtained (e.g. monitored). For example, the signal measurements may be obtained or monitored by one or more of the plurality of panels based on the at least one first sampling rates. In one example, at least one of the first sampling rate corresponds to a first sampling period of approximately 160 milliseconds (e.g. for a TTT of 160 ms).

Next, at operation 82, a determination is made (e.g. similar to operation 52) whether the difference (Pt-Ps) between the signal measurements of the target cell (Pt) and signal measurements of the serving cell is higher than a third threshold difference. The determination of whether a first condition is satisfied (e.g. operation 44) is performed based on the difference at which signal measurement(s) relating to a target cell (Pt) of the user device is higher than signal measurement(s) relating to a serving cell (Ps) of the user device. For example, the first condition is satisfied when the difference is higher than the first threshold difference.

In response to determining that the difference is higher than the first threshold difference, operation 83 is performed, where at least one of the respective first sampling rates is increased to one or more second sampling rates (e.g. similar to operation 46 and 53). In one example, at least one of the second sampling rates corresponds to a second sampling period of 100 milliseconds.

Next, at operation 84 (similar to operation 63), a determination is made of whether an elapsed time since a trigger event (e.g. A3 trigger event) is higher than a third threshold time. The trigger event may occur when signal measurements corresponding to a target cell is higher, at least by a first offset value, than signal measurements corresponding to a serving cell (Pt>Ps). If the elapsed time is higher than the third threshold time, operation 85 (similar to operation 64) is performed where at least one of the respective second sampling rates is increased to one or more fourth sampling rates. In one example, at least one of the fourth sampling rates corresponds to a fourth sampling period of 80 milliseconds.

Next, at operation 86 (similar to operation 72), the user device determines at least one of whether conditional handover condition is satisfied or whether a handover preparation is complete. In response to determining that the handover condition is satisfied or the handover preparation is complete, operation 87 is performed (similar to operation 73) by increasing at least one of the respective fourth sampling rates to respective fifth sampling rates. In one example, at least one of the fifth sampling rate corresponds to a fifth sampling period of 60 milliseconds. In response to determining that the handover condition is not satisfied or the handover preparation is not complete, operation 86 may be repeated for monitoring the handover condition or handover preparation.

In an example embodiment, the at least one of the fifth sampling rates is further increased to a one or more sixth sampling rates in the event that a fifth condition is satisfied, where the fifth condition is satisfied when a handover execution condition is satisfied. In one example, at least one of the sixth sampling rates corresponds to a sixth sampling period of 20 milliseconds.

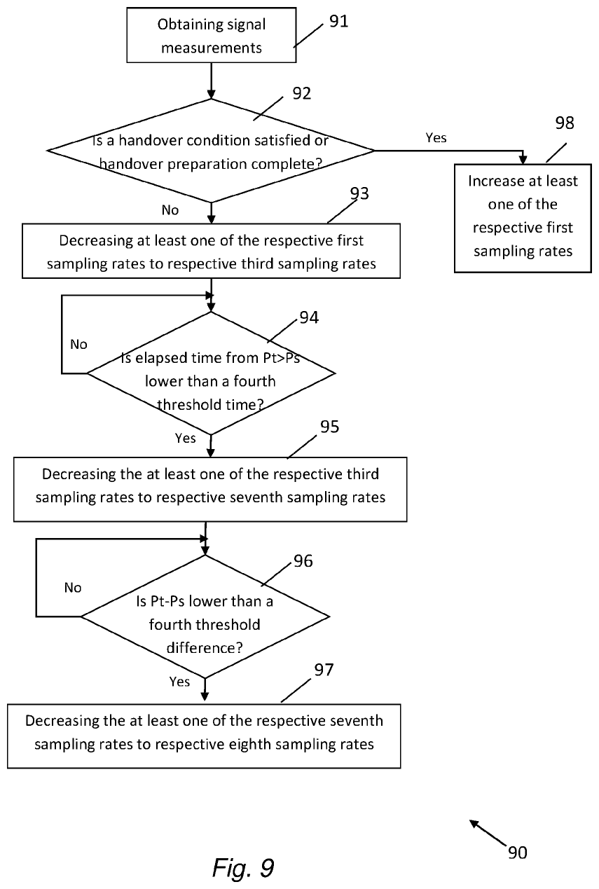

FIG. 9 is a flowchart of an algorithm, indicated generally by the reference numeral 90, in accordance with an example embodiment. The algorithm 90 may be a combination of the operations of algorithms 50, 60 implemented in a hierarchical order. The algorithm 90 may be implemented in scenarios where it may be appropriate to decrease sampling rate(s), for example, due to a user device moving from a cell edge to a cell centre.

The algorithm 90 starts with operation 91 by obtaining (or monitoring) signal measurements, for example, signal measurements (Ps) relating to at least one serving cell and signal measurements (Pt) relating to at least one target cell are obtained (e.g.

monitored). For example, the signal measurements may be obtained or monitored by one or more of the plurality of panels based on the at least one first sampling rates. In one example, at least one of the first sampling rates corresponds to a first sampling period of approximately 40 milliseconds (e.g. for a TTT of 160 ms).

Next, at operation 92, the user device determines at least one of whether conditional handover condition is satisfied or whether a handover preparation is complete. In response to determining that the handover condition is satisfied or the handover preparation is complete, operation 98 is performed (similar to operation 73 and 87) by increasing at least one of the respective first sampling rates.

If a handover condition is not satisfied or a handover preparation is not complete (e.g. indication of the user device being away from a cell border), the user device performs operation 93 where at least one of the respective first sampling rates is decreased to one or more respective third sampling rates. In one example, at least one of the third sampling rates corresponds to a third sampling period of 80 milliseconds

Next, at operation 94 (similar to operation 65), a determination is made of whether an elapsed time since a trigger event (e.g. A3 trigger event) is lower than a fourth threshold time. The trigger event may occur when signal measurements corresponding to a target cell is higher, at least by a first offset value, than signal measurements corresponding to a serving cell (Pt>Ps). If the elapsed time is not lower than the fourth threshold time, operation 94 may be repeated to monitor the elapsed time. If the elapsed time is lower than the fourth threshold time, operation 95 (similar to operation 66) is performed where at least one of the respective third sampling rates is increased to one or more seventh sampling rates. In one example, at least one of the seventh sampling rates corresponds to an seventh sampling period of 100 milliseconds.

Next, at operation 96, a determination is made (e.g. similar to operation 54) whether the difference (Pt-Ps) between the signal measurements of the target cell (Pt) and signal measurements of the serving cell is lower than a fourth threshold difference (e.g. determining whether the second condition, according to operation 44, is satisfied). If the difference is not lower than the fourth threshold difference, operation 96 may be repeated to monitor the difference.

In response to determining that the difference is higher than the fourth threshold difference, operation 97 is performed, where at least one of the respective seventh sampling rates is decreased to one or more eighth sampling rates (e.g. similar to operation 48 and 55). In one example, at least one of the eighth sampling rates corresponds to an eighth sampling period of 160 milliseconds.

It would be appreciated that the first, second, third, fourth, fifth, sixth, seventh, and/or eighth sampling rates (and corresponding respective sampling periods) may be dependent upon various factors such as the Synchronization Signal Block (SSB) periodicity (e.g. of the target cell), TTT period, UE implementation, the mobility scenario, or the like. As such, the numerical examples are provided as examples only, and are not meant to limit the scope of the example embodiments.

The example embodiments described above provide techniques for controlling UE sampling rates based on the likelihood of a handover or mobility event occurring relatively soon. For example, as the UE moves from cell centre to cell edge and UE increases the sampling rate in order to achieve accurate measurements and improve mobility performance. The reverse behaviour may also be applicable, for example a handover becoming less likely over time, e.g., UE moves from cell edge to cell centre, and UE decreases the sampling rate over time for power saving. The example embodiments described may enable UEs to improve the measurement accuracy by increasing the sampling rate per panel on relevant panels only if it is necessary such that the mobility performance is improved and unnecessary power consumption is avoided.

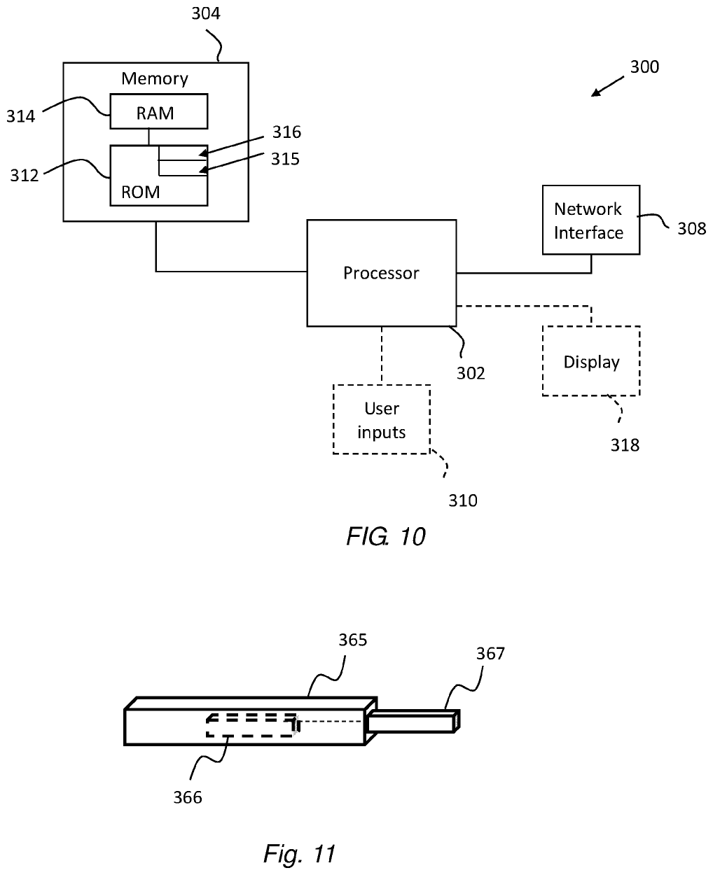

For completeness, FIG. 10 is a schematic diagram of components usable to implement one or more of the example embodiments described previously, which hereafter are referred to generically as processing system 300. A processing system 300 may have a processor 302, a memory 304 coupled to the processor and comprised of a RAM 314 and ROM 312, and, optionally, user input 310 and a display 318. The processing system 300 may comprise one or more network/apparatus interfaces 308 for connection to a network/apparatus, e.g. a modem which may be wired or wireless. Interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid-state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain instructions, such as for example computer program code which, when executed by the processor implements aspects of the algorithms 40, 50, 60, 70, 80, and 90 described above. Note that in the case of small device/apparatus the memory can be most suitable for small size usage i.e. not always hard disk drive (HDD) or solid-state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

FIG. 11 shows tangible media, specifically a removable memory unit 365, storing computer-readable code which when run by a computer may perform methods according to example embodiments described above. The removable memory unit 365 may be a memory stick, e.g. a USB memory stick, having internal memory 366 for storing the computer-readable code. The internal memory 366 may be accessed by a computer system via a connector 367. Other forms of tangible storage media may be used. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

As used in this application, the term “circuitry” refers to all of the following: (a) hardware-only circuit implementations (such as implementations in only analogue and/or digital circuitry) and (b) to combinations of circuits and software (and/or firmware), such as (as applicable): (i) to a combination of processor(s) or (ii) to portions of processor(s)/software (including digital signal processor(s)), software, and memory (ies) that work together to cause an apparatus, such as a server, to perform various functions) and (c) to circuits, such as a microprocessor(s) or a portion of a microprocessor(s), that require software or firmware for operation, even if the software or firmware is not physically present.

If desired, the different functions discussed herein may be performed in a different order and/or concurrently with each other. Furthermore, if desired, one or more of the above-described functions may be optional or may be combined. Similarly, it will also be appreciated that the flow chart of FIGS. 4 to 9 is an example only and that various operations depicted therein may be omitted, reordered and/or combined.

It will be appreciated that the above described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1-17. (canceled)

18. An apparatus comprising:
at least one processor; and
at least one memory including computer program code which, when executed by the at least one processor, causes the apparatus at least to:
obtain signal measurements from a plurality of antenna panels of a user device at respective first sampling rates corresponding to each antenna panel of the plurality of antenna panels, wherein a rate at which each antenna panel of the plurality of antenna panels performs signal measurements is determined based on the respective first sampling rates;
determine at least one of whether a first condition is satisfied or whether a second condition is satisfied, wherein at least one of the first condition or the second condition relates to probability of an inbound handover; and
increase at least one of the first sampling rates to one or more respective second sampling rates in response to determining that the first condition is satisfied, or decreasing at least one of the first sampling rates to one or more respective third sampling rates in response to determining that the second condition is satisfied.

19. An apparatus as claimed in claim 18, further configured to select at least one of the respective first sampling rates to be increased, based at least partially, on a determination of at least one antenna panel of the plurality of panels that is used for obtaining signal measurements relating to a serving cell and a target cell.

20. An apparatus as claimed in claim 18, wherein the determination of whether the first condition is satisfied is performed based on a difference at which a signal measurement relating to a/the target cell is higher than a signal measurement relating to a/the serving cell, wherein the first condition is satisfied when the difference is higher than a first threshold difference.

21. An apparatus as claimed in claim 18, wherein the determination of whether the second condition is satisfied is performed based on a/the difference at which a signal measurement relating to a/the target cell is higher than a signal measurement relating to a/the serving cell, wherein the second condition is satisfied when the difference is lower than a second threshold difference.

22. An apparatus as claimed in claim 18, wherein the determination of whether the first condition is satisfied is performed based on an elapsed time since a trigger event, wherein the trigger event occurs in response to a signal measurement corresponding to a/the target cell being higher, by at least a first offset value, than a signal measurement corresponding to a/the serving cell, wherein the first condition is satisfied if the elapsed time is higher than a first threshold time.

23. An apparatus as claimed in claim 22, wherein the determination of whether the second condition is satisfied is performed based on the elapsed time since the trigger event, wherein the second condition is satisfied if the elapsed time is lower than a second threshold time.

24. An apparatus as claimed in claim 18, wherein the first condition is satisfied in response to at least one of: determining that a conditional handover condition is satisfied, or a handover preparation is complete.

25. An apparatus as claimed in claim 18, wherein the second condition is satisfied in response to determining that determining that a conditional handover condition is not satisfied, or a handover preparation is not complete.

26. An apparatus as claimed in claim 18, wherein the first condition is satisfied in response to determining that a difference at which a signal measurement relating to a target cell of the user device is higher than a signal measurement relating to a serving cell of the user device, is higher than a third threshold difference; and the apparatus is further configured to:
increase at least one of the second sampling rates to one or more respective fourth sampling rates in the event that a third condition is satisfied, wherein the third condition is satisfied in response to determining that an elapsed time since a trigger event is higher than a third threshold time, wherein the trigger event occurs in response to a signal measurement corresponding to a target cell being higher, by at least a first offset value, than a signal measurement corresponding to a serving cell; and
increase at least one of the fourth sampling rates to one or more respective fifth sampling rates in the event that a fourth condition is satisfied, wherein the fourth condition is satisfied in response to at least one of: determining that a conditional handover condition is satisfied or a handover preparation is complete.

27. An apparatus as claimed in claim 26, further configured to:
increase at least one of the fifth sampling rates to one or more sixth sampling rates in the event that a fifth condition is satisfied, wherein the fifth condition is satisfied when a handover execution condition is satisfied.

28. An apparatus as claimed in claim 18, wherein the second condition is satisfied in response to determining that a conditional handover condition is not satisfied, or a handover preparation is not complete; and the apparatus is further configured to:
decrease at least one of the third sampling rates to one or more respective seventh sampling rates in the event that a sixth condition is satisfied, wherein the sixth condition is satisfied in response to determining that an elapsed time since a trigger event is lower than a fourth threshold time, wherein the trigger event occurs in response to a signal measurement corresponding to a target cell being higher, by at least a first offset value, than a signal measurement corresponding to a serving cell; and
decrease at least one of the seventh sampling rates to one or more respective eighth sampling rates in the event that a seventh condition is satisfied, wherein the seventh condition is satisfied in response to determining that a difference, at which a signal measurement relating to a/the target cell is higher than a signal measurement relating to a/the serving cell, is lower than a fourth difference threshold.

29. A method comprising:
obtaining signal measurements from a plurality of antenna panels of a user device at respective first sampling rates corresponding to each antenna panel of the plurality of antenna panels, wherein a rate at which each antenna panel of the plurality of antenna panels performs signal measurements is determined based on the respective first sampling rates;
determining at least one of whether a first condition is satisfied or whether a second condition is satisfied, wherein at least one of the first condition or the second condition relates to a probability of an inbound handover; and
increasing at least one of the respective first sampling rates to one or more respective second sampling rates in response to determining that the first condition is satisfied, or decreasing at least one of the first sampling rates to one or more respective third sampling rates in response to determining that the second condition is satisfied.

30. A method as claimed in claim 29, further comprising selecting at least one of the respective first sampling rates to be increased, based at least partially, on a determination of at least one antenna panel of the plurality of panels that is used for obtaining signal measurements relating to a serving cell and a target cell.

31. A method as claimed in claim 29, wherein the first condition is satisfied in response to determining that a difference at which a signal measurement relating to a target cell of the user device is higher than a signal measurement relating to a serving cell of the user device, is higher than a third threshold difference; and the method further comprising:
increasing at least one of the second sampling rates to one or more respective fourth sampling rates in the event that a third condition is satisfied, wherein the third condition is satisfied in response to determining that an elapsed time since a trigger event is higher than a third threshold time, wherein the trigger event occurs in response to a signal measurement corresponding to a target cell being higher than a signal measurement corresponding to a serving cell;
increasing at least one of the fourth sampling rates to one or more respective fifth sampling rates in the event that a fourth condition is satisfied, wherein the fourth condition is satisfied in response to determining that at least one of: a conditional handover condition is satisfied or a handover preparation is complete.

32. A method as claimed in claim 29, wherein the second condition is satisfied in response to determining that a conditional handover condition is not satisfied, or a handover preparation is not complete; and the method further comprising:
decreasing at least one of the third sampling rates to one or more respective seventh sampling rates in the event that a sixth condition is satisfied, wherein the sixth condition is satisfied in response to determining that an elapsed time since a trigger event is lower than a fourth threshold time, wherein the trigger event occurs in response to a signal measurement corresponding to a target cell being higher, by at least a first offset value, than a signal measurement corresponding to a serving cell; and
decreasing at least one of the seventh sampling rates to one or more respective eighth sampling rates in the event that a seventh condition is satisfied, wherein the seventh condition is satisfied in response to determining that a difference, at which a signal measurement relating to a/the target cell is higher than a signal measurement relating to a/the serving cell, is lower than a fourth difference threshold.

33. A computer program comprising instructions for causing an apparatus to perform at least the following:
obtaining signal measurements from a plurality of antenna panels of a user device at respective first sampling rates corresponding to each antenna panel of the plurality of antenna panels, wherein a rate at which each antenna panel of the plurality of antenna panels performs signal measurements is determined based on the respective first sampling rates;
determining at least one of whether a first condition is satisfied or whether a second condition is satisfied, wherein at least one of the first condition or the second condition relates to probability of an inbound handover; and
increasing at least one of the first sampling rates to one or more respective second sampling rates in response to determining that the first condition is satisfied, or decreasing at least one of the first sampling rates to one or more respective third sampling rates in response to determining that the second condition is satisfied.
